(19) United States
(12) Patent Application Publication
(10) Pub. No.: US 2021/0239198 A1
(43) Pub. Date: Aug. 5, 2021

(54) POWER TRANSMISSION APPARATUS

(71) Applicant: AISIN SEIKI KABUSHIKI KAISHA, Kariya-shi (JP)

(72) Inventors: Norio YONEZAWA, Nagakute-shi (JP); Shigefumi MORI, Kariya-shi (JP); Tomoyuki TOYAMA, Kariya-shi (JP)

(73) Assignee: AISIN SEIKI KABUSHIKI KAISHA, Kariya-shi (JP)

(21) Appl. No.: 17/165,225

(22) Filed: Feb. 2, 2021

(30) Foreign Application Priority Data
Feb. 3, 2020 (JP) 2020-016142

(51) Int. Cl. F16H 33/02

(52) U.S. Cl. CPC F16H 33/02; F16H 2706/00

(57) ABSTRACT

A power transmission apparatus includes an input shaft inputting power, an output shaft outputting power, an energy storage portion arranged between the input shaft and the output shaft and configured to store energy sent from the input shaft, and a power transmission portion allowing a difference between a rotation speed of the input shaft and a rotation speed of the output shaft, the power transmission portion including a portion serving as an elastic body that is configured to store torsional deformation, the energy storage portion converting a kinetic energy into a different energy from the kinetic energy and storing the converted energy to achieve power transmission between the input shaft and the output shaft including different rotation speeds from each other.

### CROSS REFERENCE TO RELATED APPLICATIONS

This application is based on and claims priority under 35 U.S.C. § 119 to Japanese Patent Application 2020-016142, filed on Feb. 3, 2020, the entire content of which is incorporated herein by reference.

### TECHNICAL FIELD

This disclosure generally relates to a power transmission apparatus.

### BACKGROUND DISCUSSION

A known power transmission apparatus configured to transmit elastic energy of an elastic body with a relatively simple structure is disclosed in JP2018-40379A, for example. Such power transmission apparatus using a principle of pulse drive (intermittent drive) transmission (PDT) achieves intermittent (pulsed) driving power (i.e., torque) that is transmitted from an input shaft to an output shaft.

The principle of pulse drive transmission (PDT) is expected to achieve downsizing and high efficiency of the apparatus because of no restriction by a geometric configuration of a gear mechanism or no sliding loss by friction heating generated by a belt-type continuously variable transmission (CVT), for example. Nevertheless, in order to obtain output by intermittent power transmission substantially the same as output by continuous power transmission such as by a gear, for example, large instantaneous output is necessary for intermittent power transmission. High mechanical strength is thus necessary to endure large instantaneous output, which may also require suppression of power pulsation. Specifically, a passive pulse drive (PPD) transmission having a simple construction and high feasibility may have a small output per size of the apparatus (transmission).

A need thus exists for a power transmission apparatus which is not susceptible to the drawback mentioned above.

### SUMMARY

According to an aspect of this disclosure, a power transmission apparatus includes an input shaft inputting power, an output shaft outputting power, an energy storage portion arranged between the input shaft and the output shaft and configured to store energy sent from the input shaft, and a power transmission portion allowing a difference between a rotation speed of the input shaft and a rotation speed of the output shaft, the power transmission portion including a portion serving as an elastic body that is configured to store torsional deformation, the energy storage portion converting a kinetic energy into a different energy from the kinetic energy and storing the converted energy to achieve power transmission between the input shaft and the output shaft including different rotation speeds from each other.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating a construction of a power transmission apparatus according to an embodiment disclosed here;

FIG. 2 is a diagram illustrating a construction of known acceleration passive pulse drive;

FIGS. 3A and 3B are diagrams each illustrating an example of a construction of acceleration passive pulse drive according to the embodiment;

FIG. 4 is a diagram illustrating a construction of known deceleration passive pulse drive;

FIGS. 5A and 5B are diagrams each illustrating an example of a construction of deceleration passive pulse drive according to the embodiment;

FIG. 6 illustrates characteristics of the known acceleration passive pulse drive;

FIG. 7 illustrates characteristics of the example of the acceleration passive pulse drive according to the embodiment;

FIG. 8 illustrates characteristics of the known acceleration passive pulse drive;

FIG. 9 illustrates characteristics of the example of the acceleration passive pulse drive according to the embodiment;

FIGS. 10A, 10B, and 10C illustrate characteristics of the acceleration passive pulse drive per speed change point;

FIG. 11 illustrates characteristics of the known acceleration passive pulse drive;

FIG. 12 illustrates characteristics of example of the acceleration passive pulse drive according to the embodiment;

FIG. 13 illustrates characteristics of the known deceleration passive pulse drive;

FIG. 14 illustrates characteristics of the example of the deceleration passive pulse drive according to the embodiment;

FIG. 15 illustrates characteristics of the known deceleration passive pulse drive;

FIG. 16 illustrates characteristics of the example of the deceleration passive pulse drive according to the embodiment;

FIGS. 17A, 17B, and 17C illustrate characteristics of the deceleration passive pulse drive per speed change point;

FIG. 18 illustrates characteristics of the known deceleration passive pulse drive; and

FIG. 19 illustrates characteristics of the example of the deceleration passive pulse drive according to the embodiment.

### DETAILED DESCRIPTION

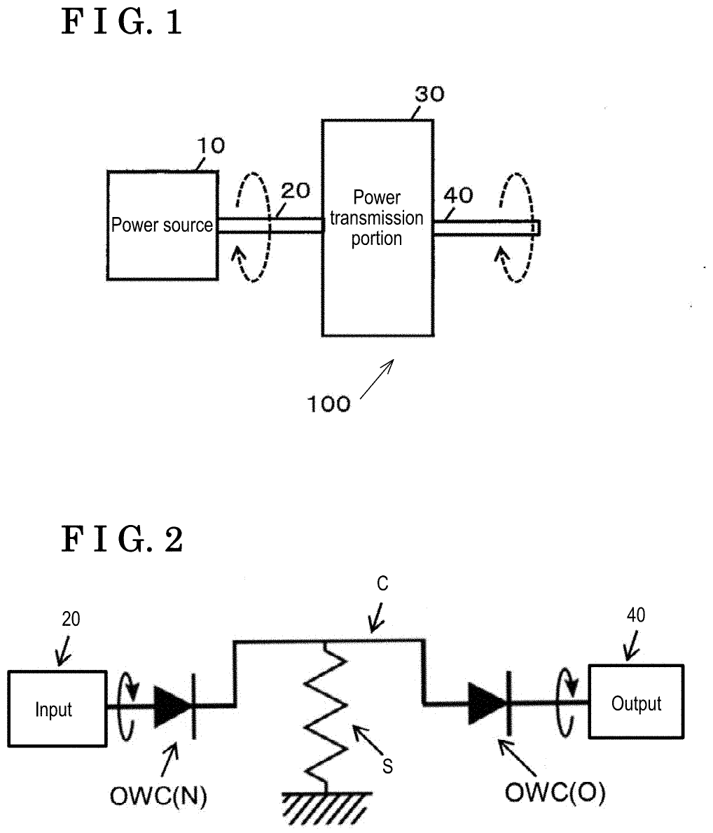

A power transmission apparatus 100 in this disclosure includes a power source 10, an input shaft 20, a power transmission portion (power transmission mechanism) 30, and an output shaft 40 as illustrated in FIG. 1.

The power transmission apparatus 100 drives and rotates the output shaft 40 using power obtained from the power source 10. The power source 10 is an electric motor or an engine, for example. The power obtained from the power source 10 is input to the input shaft 20 and transmitted to the output shaft 40 through the power transmission portion 30.

The power transmission portion 30 repeatedly performs an operation to store or accumulate at least a portion of energy (power) obtained from the input shaft 20 and to send the stored (accumulated) energy to at least one of the input shaft 20 and the output shaft 40. The power transmission portion 30 thus transmits power to the output shaft 40 from the input shaft 20. Specifically, the power transmission portion 30 functions as an energy storage portion storing energy of power sent from the input shaft 20.

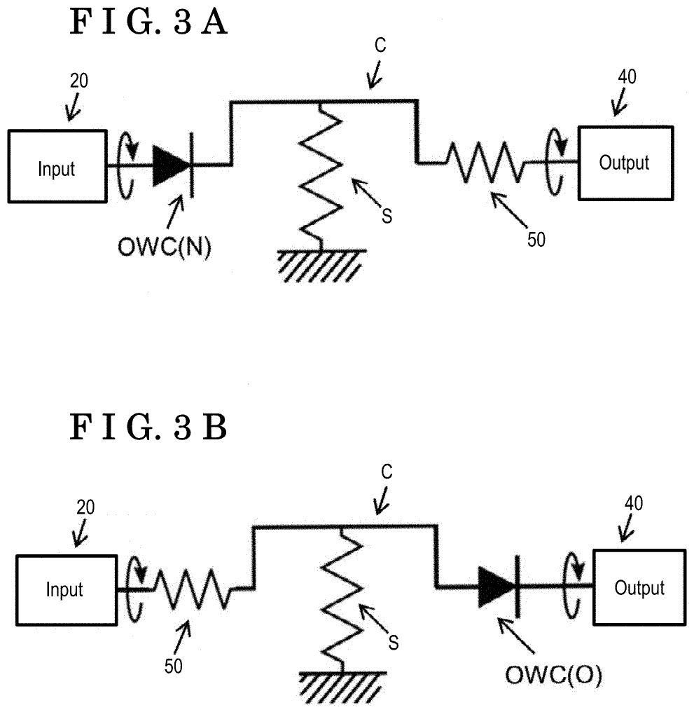

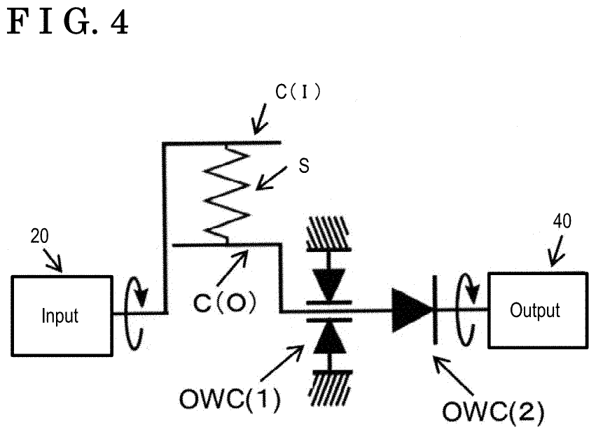

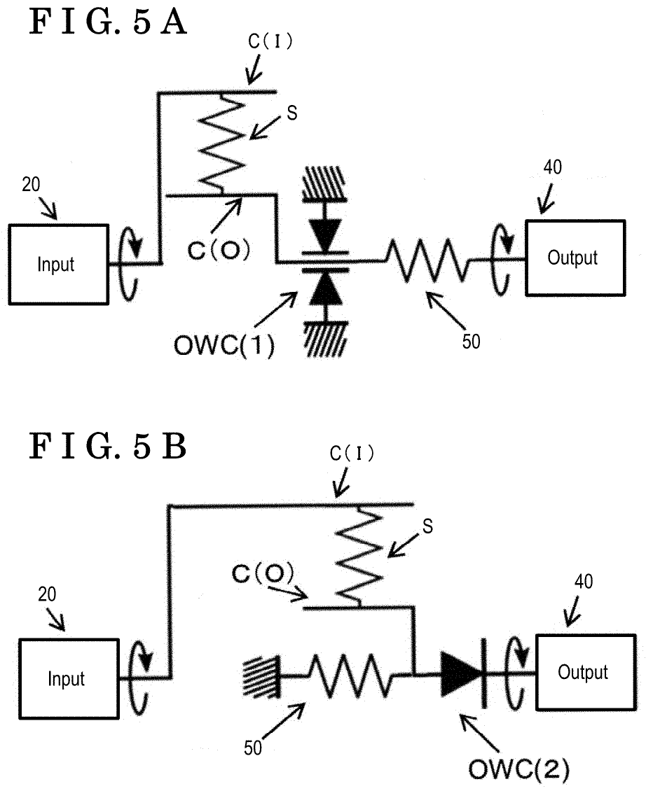

FIGS. 2 to 5 are examples of the power transmission portion 3 of pulse drive (i.e., intermittent drive) type. Specifically, FIGS. 2 and 3 illustrate examples of acceleration passive pulse drive (PPD) (i.e., acceleration drive type) and FIGS. 4 and 5 illustrate examples of deceleration passive pulse drive (PPD) (i.e., deceleration drive type).

FIG. 2 is a known acceleration passive pulse drive (PPD). The input shaft 20 rotates a crank C via a one-way clutch OWC (N) so that a spring S stores elastic energy. The spring S rotates the crank C by the stored elastic energy so that the elastic energy is released. This causes the output shaft 40 to rotate via a one-way clutch OWC (O). The power obtained from the input shaft 20 is thus intermittently transmitted to the output shaft 40.

FIG. 3A is an example of improved acceleration passive pulse drive (PPD). The input shaft 20 rotates the crank C via the one-way clutch OWC (N) so that the spring S stores elastic energy. The spring S rotates the crank C by the stored elastic energy so that the elastic energy is released. This causes the output shaft 40 including a torsion spring 50 to rotate. The power obtained from the input shaft 20 is thus intermittently transmitted to the output shaft 40.

FIG. 3B is another example of improved acceleration passive pulse drive (PPD). The input shaft 20 rotates the crank C via the torsion spring 50 so that the spring S stores elastic energy. The spring S rotates the crank C by the stored elastic energy so that the elastic energy is released. This causes the output shaft 40 including the one-way clutch OWC (O) to rotate. The power obtained from the input shaft 20 is thus intermittently transmitted to the output shaft 40.

FIG. 4 is a known deceleration passive pulse drive (PPD). The input shaft 20 rotates a crank C (I) so that a crank C (O) rotates by a reaction force of the spring S. This causes the output shaft 40 to be driven via a one-way clutch OWC (1) and a one-way clutch OWC (2). Additionally, the spring S stores elastic energy in accordance with a difference in rotation between the input shaft 20 and the output shaft 40. Such stored elastic energy returns to the input shaft 20 to be used for assisting the next driving (i.e., torque increase). The power obtained from the input shaft 20 is thus intermittently transmitted to the output shaft 40.

FIG. 5A is an example of improved deceleration passive pulse drive (PPD). The input shaft 20 rotates the crank C (I) so that the crank C (O) rotates by a reaction force of the spring S. This causes the output shaft 40 to be driven via the one-way clutch OWC (1) and the torsion spring 50. At this time, the spring S stores elastic energy in accordance with a difference in rotation between the input shaft 20 and the output shaft 40. A portion of the stored elastic energy serves as elastic energy of the torsion spring 50 to be transmitted to the output shaft 40 and the remaining stored elastic energy returns to the input shaft 20 to be used for assisting the next driving (i.e., torque increase). The power obtained from the input shaft 20 is thus intermittently transmitted to the output shaft 40.

FIG. 5B is another example of improved deceleration passive pulse drive (PPD). The input shaft 20 rotates the crank C (I) so that the crank C (O) rotates by a reaction force of the spring S. This causes the output shaft 40 to be driven via the torsion spring 50 and the one-way clutch OWC (2). At this time, the spring S stores elastic energy in accordance with a difference in rotation between the input shaft 20 and the output shaft 40. A portion of the stored elastic energy is transmitted, together with the elastic energy of the torsion spring 50, to the output shaft 40 and the remaining stored elastic energy of the spring S is released to the torsion spring 50 and the input shaft 20 to be used for assisting the next driving (i.e., torque increase). The power obtained from the input shaft 20 is thus intermittently transmitted to the output shaft 40.

The power transmission portion 30 of pulse drive type in this disclosure utilizes the elastic energy of the spring S (crank spring structure, reverse periodic spring) so that torque vibration and direction periodically change depending on a torsion angle of the spring S. Alternatively, instead of the elastic energy of the spring S or in addition thereto, magnetic energy of a magnet (magnetic spring structure, reverse periodic spring) may be utilized, for example. A magnetic spring as disclosed in JP2018-40379A (specifically, in FIGS. 31 and 32) may be employed as a structure where magnetic energy of a magnet is utilized, for example.

The power transmission portion 30 in this disclosure includes the one-way clutch OWC and the torsion spring 50 functioning as a power transmission portion that allows a difference in rotation speed between the input shaft 20 and the output shaft 40. The power is transmitted via the torsion spring 50 in this disclosure. The power transmission portion 30 may at least include a structure having elasticity that is able to store torsional deformation (strain) relative to the rotation of at least one of the input shaft 20 and the output shaft 40. For example, instead of rotation elasticity of the torsion spring 50, a structure where magnetic energy of a magnet is utilized may be employed. The magnetic spring as disclosed in JP2018-40379A (specifically, in FIGS. 31 and 32), for example, may be employed as the structure where magnetic energy of a magnet is utilized.

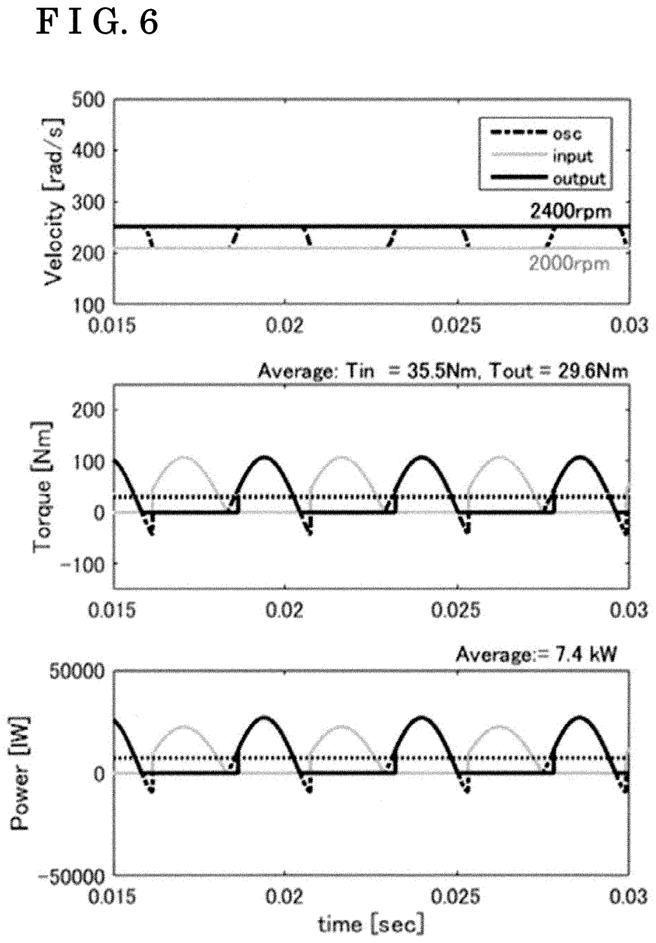

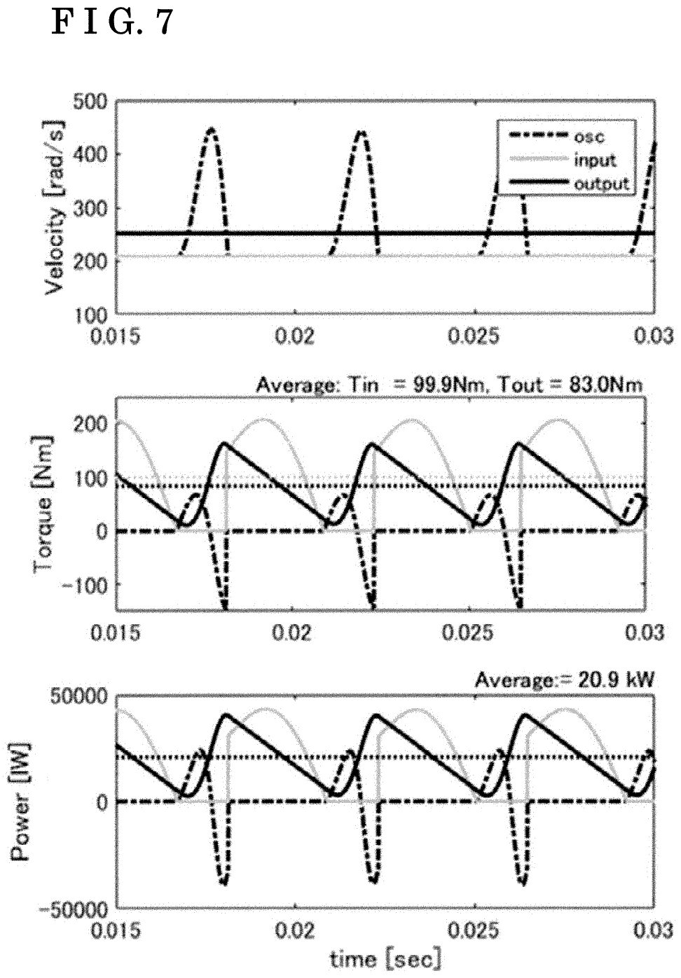

FIG. 6 illustrates characteristics of the known acceleration passive pulse drive (PPD). In graphs of FIG. 6, each horizontal axis indicates time and vertical axes indicate a velocity (rotation speed) (rad/s), torque (Nm), and power (W) in order from the top. FIG. 7 illustrates characteristics of the improved acceleration passive pulse drive (PPD) constituted by the power transmission portion 30 that includes the torsion spring 50 at the output shaft 40 as illustrated in FIG. 3A. Specifically, FIG. 7 illustrates characteristics of such improved acceleration passive pulse drive (PPD) being operated in the same condition as FIG. 6. In graphs of FIG. 7, a horizontal axis indicates time and vertical axes indicate a velocity (rotation speed) (rad/s), torque (Nm), and power (W) in order from the top. In each graph, a thin continuous line indicates characteristics of the input shaft 20, a thick continuous line indicating characteristics of the output shaft 40, and a dotted line indicating characteristics of the crank (oscillator).

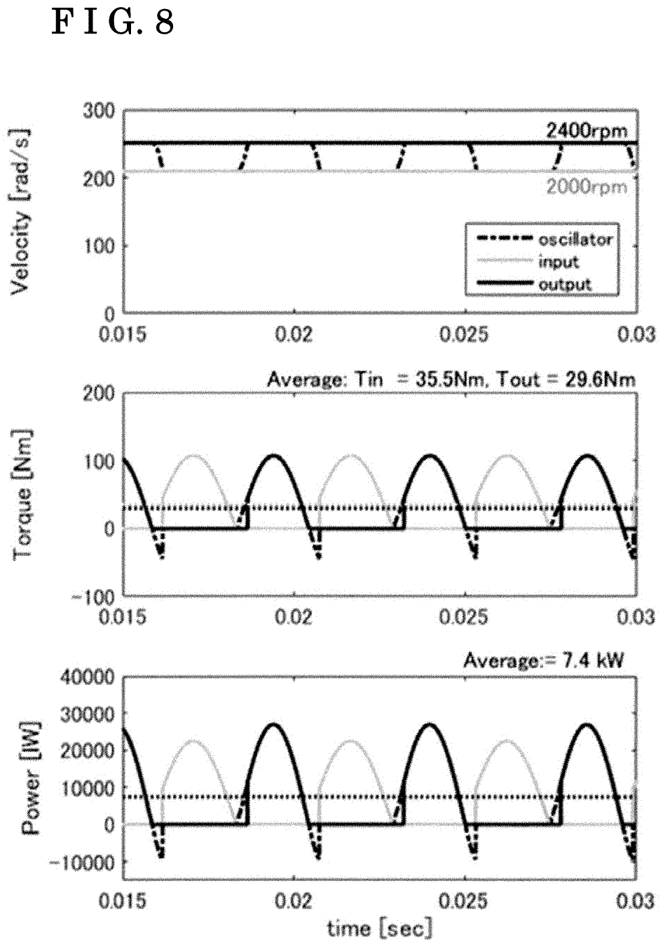

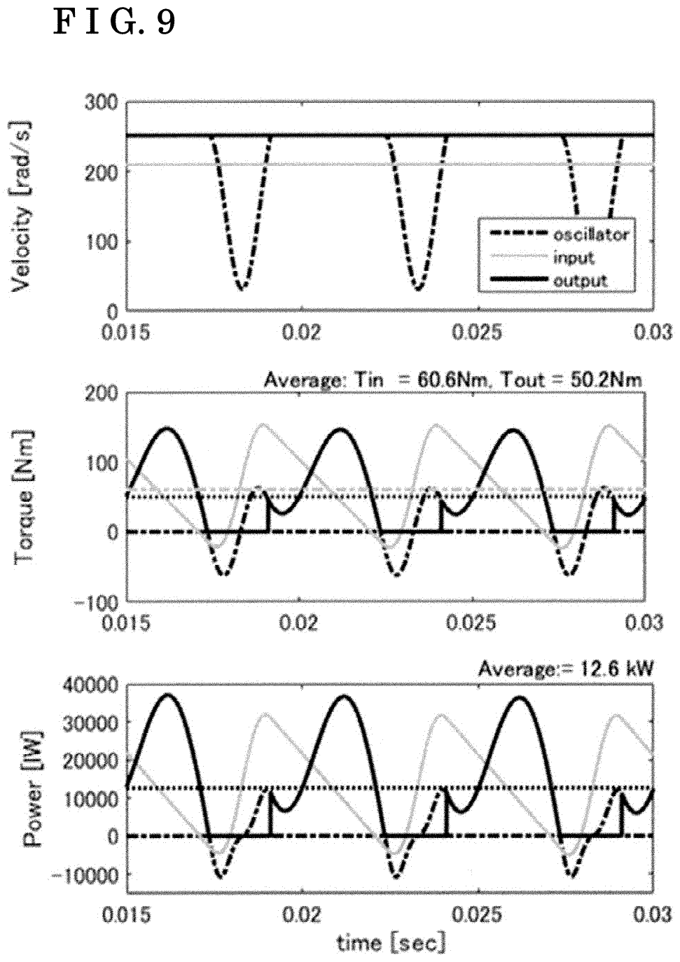

FIG. 8 illustrates characteristics of the known acceleration passive pulse drive (PPD). In graphs of FIG. 8, a horizontal axis indicates time and vertical axes indicate a velocity (rotation speed) (rad/s), torque (Nm), and power (W) in order from the top. FIG. 9 illustrates characteristics of the improved acceleration passive pulse drive (PPD) constituted by the power transmission portion 30 that includes the torsion spring 50 at the input shaft 20 as illustrated in FIG. 3B. Specifically, FIG. 9 illustrates characteristics of such improved acceleration passive pulse drive (PPD) being operated in the same condition as FIG. 8. In each graph, a thin continuous line indicates characteristics of the input shaft 20, a thick continuous line indicating characteristics of the output shaft 40, and a dotted line indicating characteristics of the crank (oscillator).

FIGS. 6 to 9 are simulation results in the operation condition where the number of input revolutions (i.e., input speed) is defined to be 2000 (rpm) and the number of output revolutions (i.e., output speed) is defined to be 2400 (rpm). In this case, the oscillator inertia (crank inertia) “I” of the power transmission portion 30, a half amplitude of periodic reverse spring torque “A”, and the number of periodic reverse rotations per rotation “N” are defined as follows:

I=1.7×10⁻⁴ [kgm²]

### A=107 [Nm]

### N=6

In addition, rotation elasticity of the torsion spring 50 arranged at the output shaft 40 is defined to be 1200 [Nm/rad].

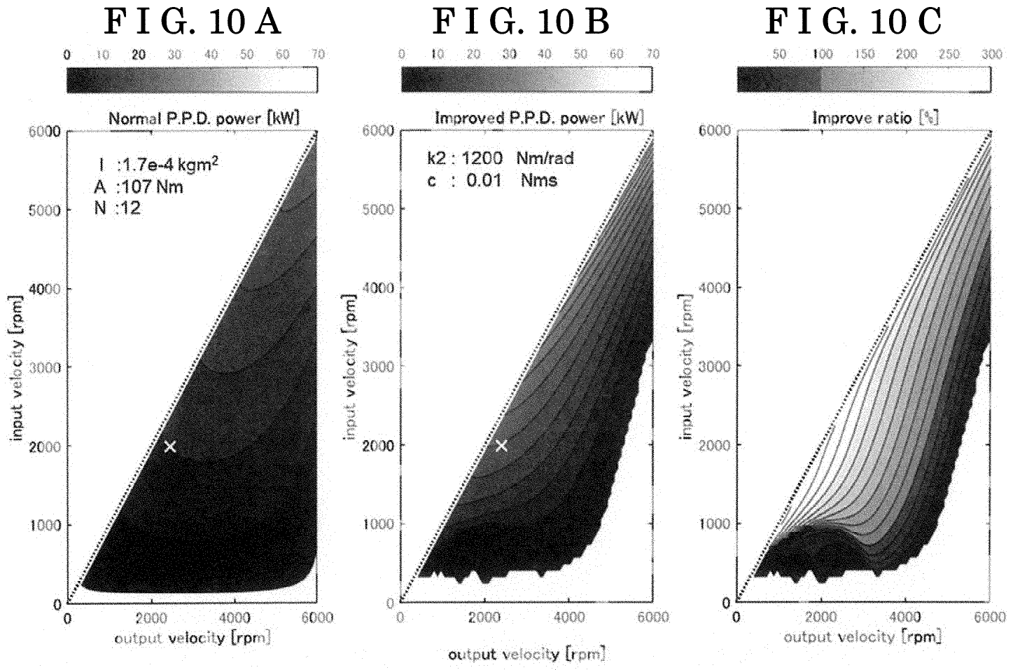

Characteristics of the known acceleration passive pulse drive (PPD) as illustrated in FIG. 6 and the improved acceleration passive pulse drive (PPD) as illustrated in FIG. 7 are explained below. FIGS. 10A to 100 are diagrams indicating the characteristics of both the known acceleration passive pulse drive (PPD) in FIG. 6 and the improved acceleration passive pulse drive (PPD) in FIG. 7. Specifically, FIG. 10A shows a simulation result of transmitted power with respective combinations of the rotation speed of the input shaft 20 and the rotation speed of the output shaft 40 according to the known acceleration passive pulse drive (PPD). FIG. 10B shows a simulation result of transmitted power with respective combinations of the rotation speed of the input shaft 20 and the rotation speed of the output shaft 40 according to the improved acceleration passive pulse drive (PPD). FIG. 100 shows a transmitted power ratio, i.e., a ratio of the transmitted power by the improved acceleration passive pulse drive (PPD) relative to the transmitted power by the known acceleration passive pulse drive (PPD). In FIGS. 10A to 100, the color intensity is higher with greater transmitted power and greater transmitted power ratio.

As illustrated in FIG. 10A, substantially the equal transmitted power is obtained over an entire speed change region according to the known acceleration passive pulse drive (PPD). Nevertheless, the magnitude of transmitted power is small. On the other hand, according to the improved acceleration passive pulse drive (PPD) as illustrated in FIG. 10B, though the transmitted power varies in the speed change region, an area with large transmitted power increases than the known acceleration passive pulse drive (PPD).

The transmitted power increases by a maximum of 300% in the improved acceleration passive pulse drive (PPD) relative to the known acceleration passive pulse drive (PPD). An average value of transmitted power ratio in a region where the input revolutions and the output revolutions are smaller than an upper limit of difference between the input revolutions and the output revolutions (i.e., 6186 rpm) is 133.6% in a state where the upper limit is determined on a basis of elastic body performance of the power transmission portion 30 and is excluded for obtaining the average value.

An area where power transmission is achievable in the speed change region of the improved acceleration passive pulse drive (PPD) is 76% relative to the known acceleration passive pulse drive (PPD). That is, an area with increased power transmission performance is inhibited from covering the entire speed change region according to the improved acceleration passive pulse drive (PPD). A part of the speed change region has decreased power transmission performance and reduced gear shift range accordingly. Such incident may be caused by that the most power transmission is made through a direct path instead of a storage path. Specifically, in the direct path, kinetic energy is directly transmitted from the input shaft 20 to the output shaft 40 via the torsion spring 50. In the storage path, kinetic energy from the input shaft 20 is once converted into elastic energy of the periodic reverse spring and is then converted into kinetic energy again. The decrease of power transmission performance is caused by the torsion spring 50 that absorbs a portion of energy of the periodic reverse spring.

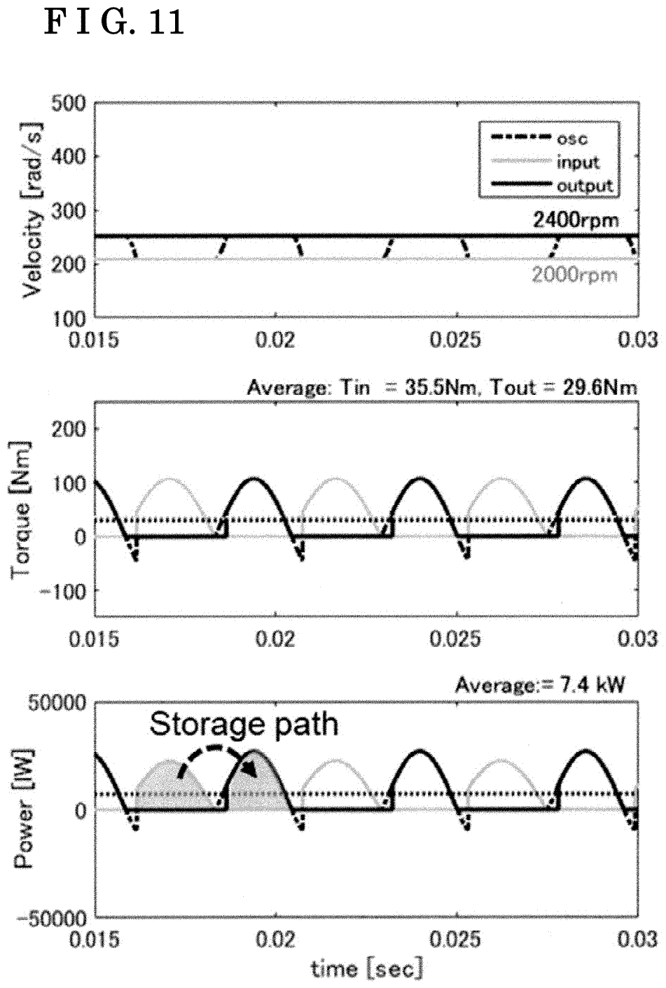

FIG. 11 is a diagram showing a velocity (rotation speed) (rad/s), torque (Nm), and power (W) relative to time (sec) with a combination of the number of input revolutions and the number of output revolutions at a white point (x) in the characteristics shown in FIG. 10A according to the known acceleration passive pulse drive (PPD). As shown in FIG. 11, the power transmission through the input shaft 20 and the power transmission through the output shaft 40 are inhibited from overlapping each other, so that direct transmission and reception of kinetic energy between the input shaft 20 and the output shaft 40 does not exist. The kinetic energy is thus transmitted entirely by means of the periodic reverse spring (crank spring structure, including the spring S). Specifically, the power transmission is not made through the direct path and is made through the storage path where the kinetic energy from the input shaft 20 is once converted to the elastic energy of the periodic reverse spring and is then reconverted to the kinetic energy to be transmitted to the output shaft 40.

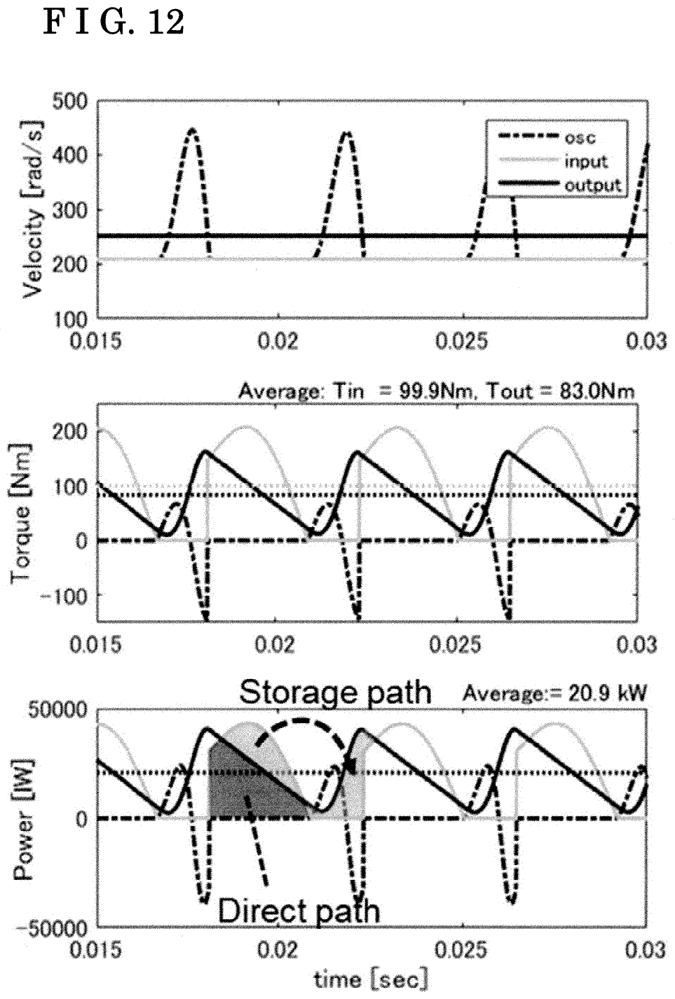

FIG. 12 is a diagram showing a velocity (rotation speed) (rad/s), torque (Nm), and power (W) relative to time (sec) with a combination of the number of input revolutions and the number of output revolutions at a white point (x) in the characteristics shown in FIG. 10B according to the improved acceleration passive pulse drive (PPD). As shown in FIG. 12, timing at which the power transmission is simultaneously made through the input shaft 20 and the output shaft 40 is obtained. Specifically, not only the storage path but also the direct path where the kinetic energy is directly transmitted from the input shaft 20 to the output shaft 40 is obtained. The direct path achieves the power transmission by reaction force of the elastic body of the torsion spring 50 that is deformed (strained) more than the rotation difference between the input shaft 20 and the output shaft 40. Specifically, the elastic body is deformed through the storage path and then the power transmission is made through the direct path after a period where the above deformation is released. The improved acceleration passive pulse drive (PPD) where the power transmission through the direct path is added achieves improved performance of power transmission than the known acceleration passive pulse drive (PPD).

Specifically, the improved acceleration passive pulse drive (PPD) includes the torsion spring 50 having a rotation elastic force that causes an overlap between a time period where the power is input through the input shaft 20 and a time period where the power is output from the output shaft 40. This achieves improved power transmission performance.

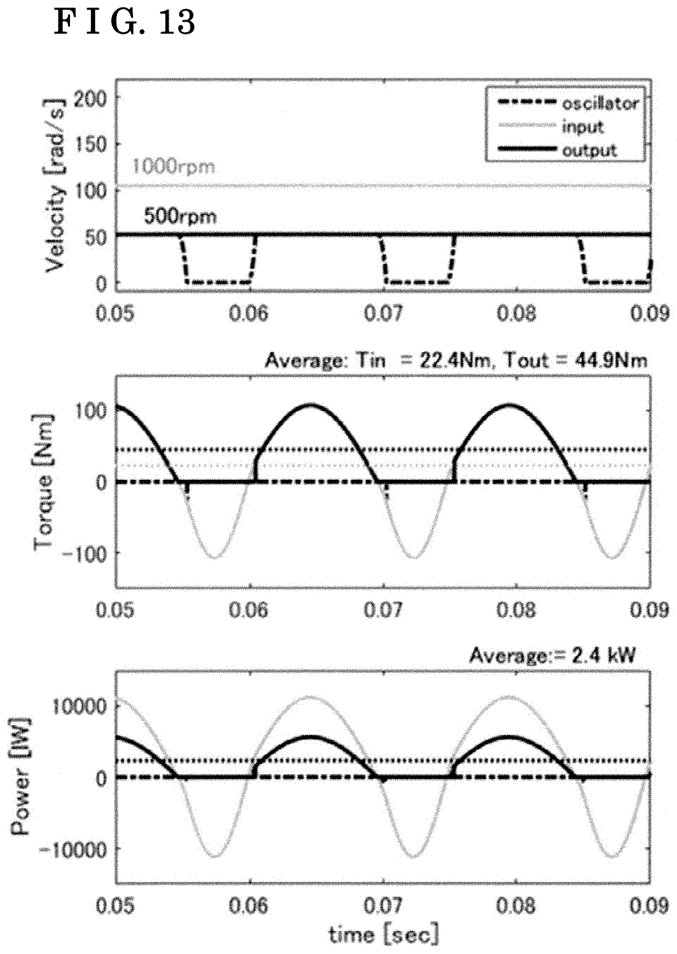

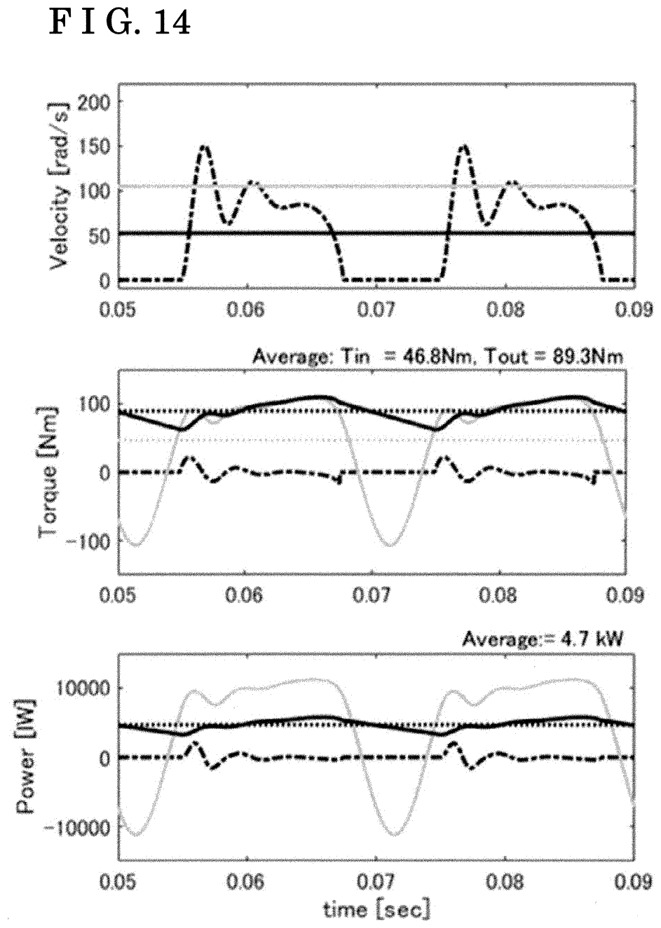

FIG. 13 illustrates characteristics of the known deceleration passive pulse drive (PPD). In graphs of FIG. 13, each horizontal axis indicates time and vertical axes indicate a velocity (rotation speed) (rad/s), torque (Nm), and power (W) in order from the top. FIG. 14 illustrates characteristics of the improved deceleration passive pulse drive (PPD) constituted by the power transmission portion 30 that includes the torsion spring 50 as illustrated in FIG. 5A. Specifically, FIG. 14 illustrates characteristics of such improved deceleration passive pulse drive (PPD) being operated in the same condition as FIG. 13. In graphs of FIG. 14, a horizontal axis indicates time and vertical axes indicate a velocity (rotation speed) (rad/s), torque (Nm), and power (W) in order from the top. In each graph, a thin continuous line indicates characteristics of the input shaft 20, a thick continuous line indicating characteristics of the output shaft 40, and a dotted line indicating characteristics of the crank (oscillator).

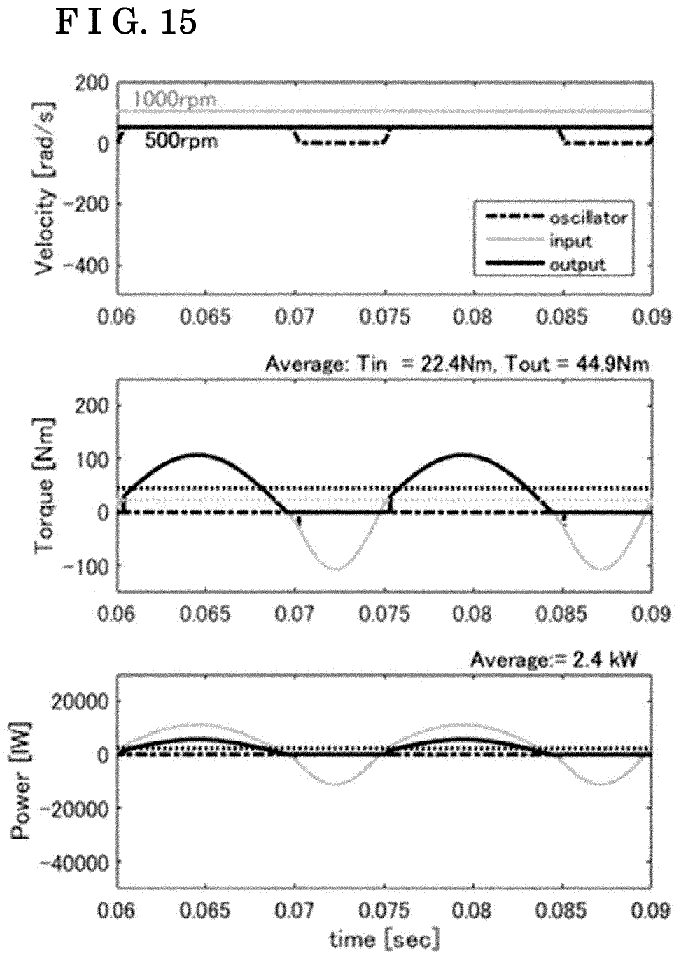

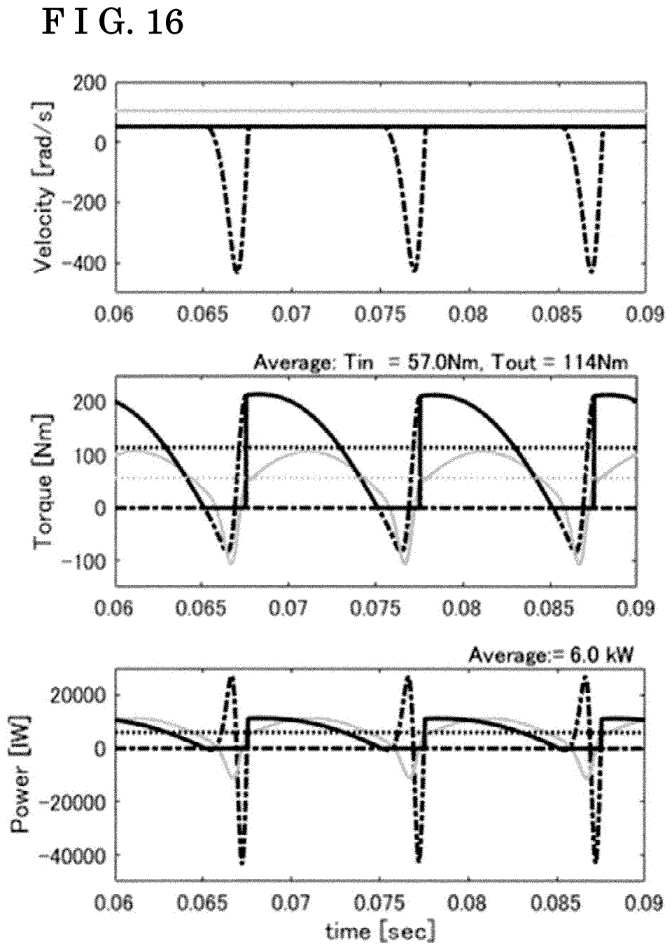

FIG. 15 illustrates characteristics of the known deceleration passive pulse drive (PPD). In graphs of FIG. 15, a horizontal axis indicates time and vertical axes indicate a velocity (rotation speed) (rad/s), torque (Nm), and power (W) in order from the top. FIG. 16 illustrates characteristics of the improved deceleration passive pulse drive (PPD) constituted by the power transmission portion 30 that includes the torsion spring 50 as illustrated in FIG. 5B. Specifically, FIG. 16 illustrates characteristics of such improved deceleration passive pulse drive (PPD) being operated in the same condition as FIG. 15. In each graph, a thin continuous line indicates characteristics of the input shaft, a thick continuous line indicating characteristics of the output shaft 40, and a dotted line indicating characteristics of the crank (oscillator).

FIGS. 13 to 16 are simulation results in the operation condition where the number of input revolutions (i.e., input speed) is defined to be 1000 (rpm) and the number of output revolutions (i.e., output speed) is defined to be 500 (rpm). In this case, the oscillator inertia (crank inertia) “I” of the power transmission portion 30, a half amplitude of periodic reverse spring torque “A”, and the number of periodic reverse rotations per rotation “N” are defined as follows:

I=1.7×10⁻⁴ [kgm²]

### A=107 [Nm]

### N=6

In addition, rotation elasticity of the torsion spring 50 arranged at the output shaft 40 is defined to be 100 [Nm/rad].

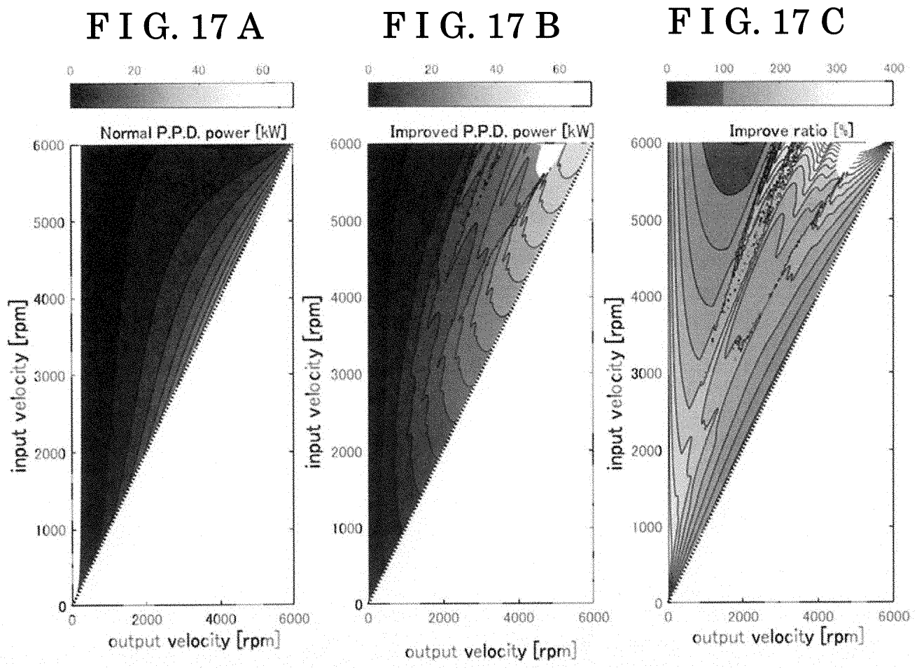

Characteristics of the known deceleration passive pulse drive (PPD) as illustrated in FIG. 13 and the improved deceleration passive pulse drive (PPD) as illustrated in FIG. 14 are explained below. FIGS. 17A to 17C are diagrams indicating the characteristics of both the known deceleration passive pulse drive (PPD) in FIG. 13 and the improved acceleration passive pulse drive (PPD) in FIG. 14. Specifically, FIG. 17A shows a simulation result of transmitted power with respective combinations of the rotation speed of the input shaft 20 and the rotation speed of the output shaft 40 according to the known deceleration passive pulse drive (PPD). FIG. 17B shows a simulation result of transmitted power with respective combinations of the rotation speed of the input shaft 20 and the rotation speed of the output shaft 40 according to the improved deceleration passive pulse drive (PPD). FIG. 17C shows a transmitted power ratio, i.e., a ratio of the transmitted power by the improved deceleration passive pulse drive (PPD) relative to the transmitted power by the known deceleration passive pulse drive (PPD). In FIGS. 17A to 17C, the color intensity is higher with greater transmitted power and greater transmitted power ratio.

As illustrated in FIG. 17A, substantially the equal transmitted power is obtained over an entire speed change region according to the known deceleration passive pulse drive (PPD). Nevertheless, the magnitude of transmitted power is small. On the other hand, according to the improved deceleration passive pulse drive (PPD) as illustrated in FIG. 17B, though the transmitted power varies in the speed change region, an area with large transmitted power increases than the known deceleration passive pulse drive (PPD).

The transmitted power increases by a maximum of 300% in the improved deceleration passive pulse drive (PPD) relative to the known deceleration passive pulse drive (PPD). An average value of transmitted power ratio in a region where the input revolutions and the output revolutions are smaller than an upper limit of difference between the input revolutions and the output revolutions (i.e., 6186 rpm) is 214.9% in a state where the upper limit is determined on a basis of elastic body performance of the power transmission portion 30 and is excluded for obtaining the average value.

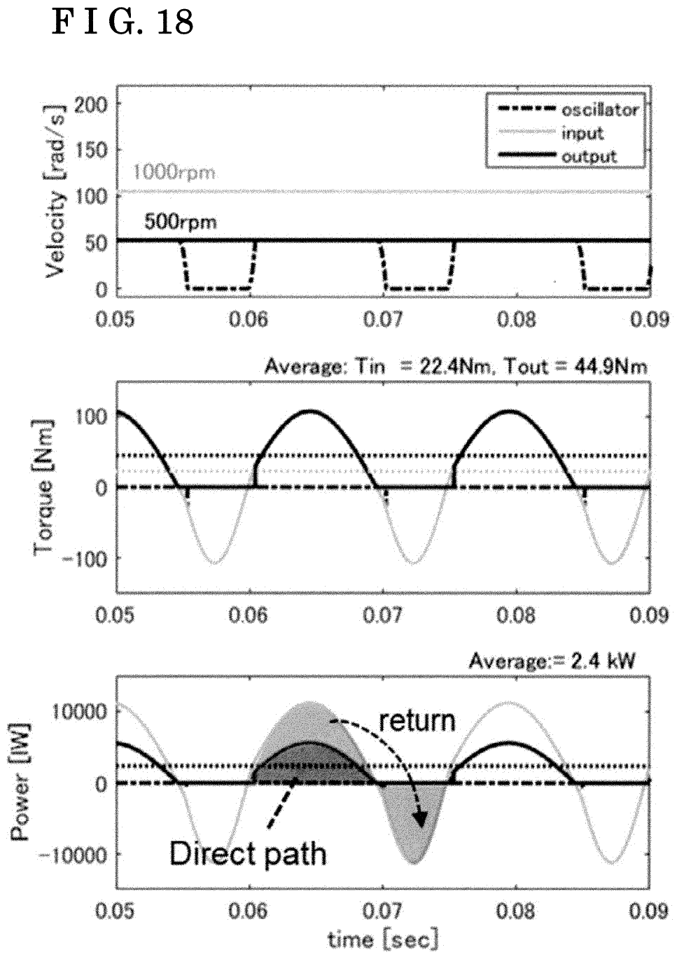

FIG. 18 is a diagram showing a velocity (rotation speed) (rad/s), torque (Nm), and power (W) relative to time (sec) with a combination of the number of input revolutions and the number of output revolutions at a white point (x) in the characteristics shown in FIG. 17A according to the known deceleration passive pulse drive (PPD). As shown in FIG. 18, the kinetic energy input from the input shaft 20 is once stored or accumulated as elastic energy of the periodic reverse spring and is then fully returned to the input shaft 20 without being transmitted to the output shaft 40. Specifically, the power transmission is made only through the direct path and is not made through the storage path where the kinetic energy from the input shaft 20 is once converted into the elastic energy of the periodic reverse spring and is then reconverted into the kinetic energy.

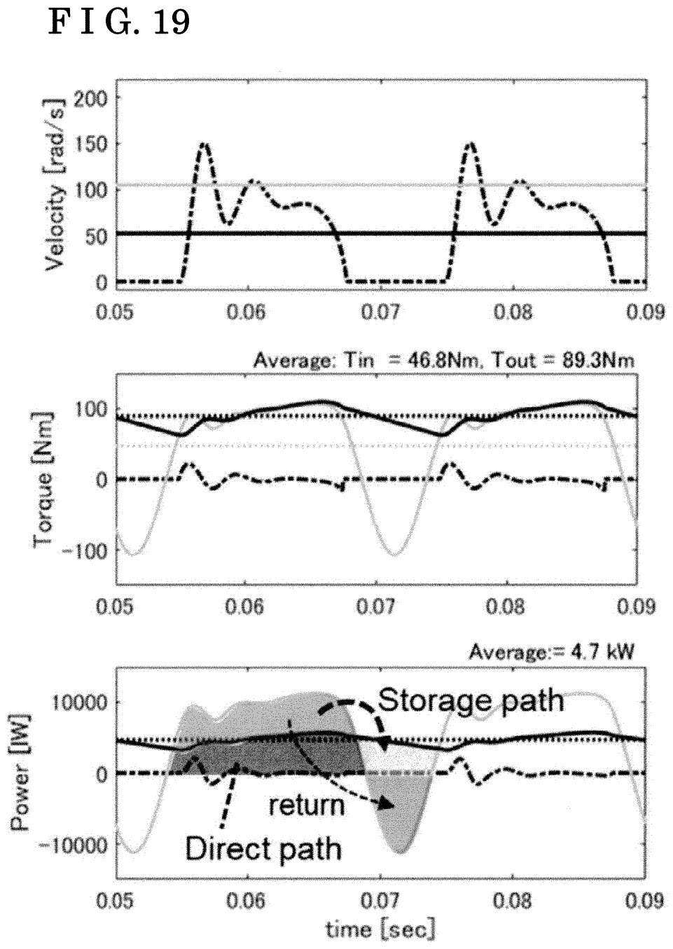

FIG. 19 is a diagram showing a velocity (rotation speed) (rad/s), torque (Nm), and power (W) relative to time (sec) with a combination of the number of input revolutions and the number of output revolutions at a white point (x) in the characteristics shown in FIG. 17B according to the improved deceleration passive pulse drive (PPD). As shown in FIG. 19, the power transmission is made not only through the direct path but also through the storage path where the kinetic energy from the input shaft 20 is once stored as the elastic energy of the periodic reverse spring and the torsion spring 50, a portion of such energy being returned to the input shaft 20 and the remaining energy being transmitted to the output shaft 40 without being returned to the input shaft 20. Timing at which energy stored at the elastic body (torsion spring 50) of the power transmission portion 30 is released to the output shaft 40 is obtained. The improved deceleration passive pulse drive (PPD) where the power transmission through the storage path is added achieves improved performance of power transmission than the known deceleration passive pulse drive (PPD).

Specifically, the improved deceleration passive pulse drive (PPD) includes the torsion spring 50 having a rotation elastic force that generates a time period where the stored energy stored at the power transmission portion 30 is released to the output shaft 40. This achieves improved power transmission performance.

The configurations of the embodiment is not limited to the above and maybe appropriately modified or changed.

The embodiment employs the torsion spring 50 (elastic body) configured to store torsional strain, instead of a construction where a one-way clutch is used to allow a speed difference between the input shaft and the output shaft by power interruption. The embodiment achieves the pulse drive allowing such speed difference without generating power interruption. This achieves continuous power transmission time (high output duty ratio) and restrains power pulsation. Increased output time causes average output to increase, which reduces instantaneous output according to the improved passive pulse drive than the known passive pulse drive in the condition of being designed with the same output.

According to this disclosure, a power transmission apparatus 100 includes an input shaft 20 inputting power, an output shaft 40 outputting power, an energy storage portion (a crank spring structure, a spring S) arranged between the input shaft 20 and the output shaft 40 and configured to store energy sent from the input shaft 20, and a power transmission portion 30 allowing a difference between a rotation speed of the input shaft 20 and a rotation speed of the output shaft 40, the power transmission portion 30 including a portion serving as an elastic body (torsion spring) 50 that is configured to store torsional deformation, the energy storage portion converting a kinetic energy into a different energy from the kinetic energy and storing the converted energy to achieve power transmission between the input shaft 20 and the output shaft 40 including different rotation speeds from each other.

The power transmission apparatus 100 includes an acceleration drive type where the rotation speed of the input shaft 20 is lower than the rotation speed of the output shaft 40. The elastic body 50 includes a rotation elastic force that causes an overlap between a time period where power is sent from the input shaft 20 and a time period where power is output from the output shaft 40.

The power transmission apparatus 100 includes a deceleration drive type where the rotation speed of the input shaft 20 is higher than the rotation speed of the output shaft 40. The elastic body 50 includes a rotation elastic force that causes energy stored at the energy storage portion to be released to the output shaft 40.

The elastic body 50 is one of a torsion spring and a magnetic spring.

The energy storage portion is a periodic reverse spring including one of a crank spring structure and a magnetic spring structure where torque vibration and direction periodically change depending on a torsion angle of the periodic reverse spring.

According to this disclosure, the power transmission apparatus 100 includes a construction where power interruption is inhibited, which restrains power pulsation and improves average output. Additionally, instantaneous output is smaller than a known apparatus, which leads to less necessity of mechanical strength of the apparatus.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A power transmission apparatus comprising:
an input shaft inputting power;
an output shaft outputting power;
an energy storage portion arranged between the input shaft and the output shaft and configured to store energy sent from the input shaft; and
a power transmission portion allowing a difference between a rotation speed of the input shaft and a rotation speed of the output shaft, the power transmission portion including a portion serving as an elastic body that is configured to store torsional deformation;
the energy storage portion converting a kinetic energy into a different energy from the kinetic energy and storing the converted energy to achieve power transmission between the input shaft and the output shaft including different rotation speeds from each other.

2. The power transmission apparatus according to claim 1, wherein
the power transmission apparatus includes an acceleration drive type where the rotation speed of the input shaft is lower than the rotation speed of the output shaft,
the elastic body includes a rotation elastic force that causes an overlap between a time period where power is sent from the input shaft and a time period where power is output from the output shaft.

3. The power transmission apparatus according to claim 1, wherein
the power transmission apparatus includes a deceleration drive type where the rotation speed of the input shaft is higher than the rotation speed of the output shaft,
the elastic body includes a rotation elastic force that causes energy stored at the energy storage portion to be released to the output shaft.

4. The power transmission apparatus according to claim 1, wherein the elastic body is one of a torsion spring and a magnetic spring.

5. The power transmission apparatus according to claim 1, wherein the energy storage portion is a periodic reverse spring including one of a crank spring structure and a magnetic spring structure where torque vibration and direction periodically change depending on a torsion angle of the periodic reverse spring.
